(19) United States
(12) Patent Application Publication
(10) Pub. No.: US 2008/0245000 A1
(43) Pub. Date: Oct. 9, 2008

(54) ACCESSORY FOR PROFILES FOR SLIDING WINDOWS OR DOORS

(75) Inventor: Marco Lambertini, San Lazzaro di Savena (Bologna) (IT)

Correspondence Address: PEARNE & GORDON LLP, 1801 EAST 9TH STREET, SUITE 1200, CLEVELAND, OH, 44114-3108, US

(73) Assignee: GSG INTERNATIONAL S.P.A., Budrio (Bologna) (IT)

(21) Appl. No.: 11/845,562

(22) Filed: Aug. 27, 2007

(30) Foreign Application Priority Data
Apr. 3, 2007 (IT) BO2007A000243

(51) Int. Cl. E06B 1/04; E04C 2/38

(52) U.S. Cl. 52/204.1; 52/717.02

(57) ABSTRACT

An accessory for profiles used for making frames for sliding windows or doors comprising, amongst other things, a fixed frame formed by two crosspieces and two stiles; the profile forming the first lower crosspiece comprises two sliding tracks, parallel with one another, presented by a lower base body, and heat insulation elements; this profile having an element for connecting and joining two halves of the profile, transversally separate relative to the length of the tracks and together forming the whole of the lower crosspiece; this connecting and joining element also has heat insulation properties.

### BACKGROUND OF THE INVENTION

The present invention relates to an accessory for profiles used for making sliding windows or doors.

The sliding windows or doors usually consist of:
a fixed frame (the most simple and usual versions also having a fixed sash positioned on a first track);
at least one movable frame or sash which slides horizontally opening and closing relative to the fixed frame (parallel with the fixed sash);
a pair of carriages, associated on the lower crosspiece of the movable sash and resting on a second horizontal track (parallel with the first track on which the fixed sash rests), and designed to allow the movable sash to slide in both directions;
a control element positioned on the sash and designed to control operating means with which it is possible, respectively, to release the sash relative to the fixed frame and allow it to slide so that it opens, and to lock the sash in a closed position, in which it is stably associated with the fixed frame;
closing means acting at least between the vertical stile of the sash and the vertical stile of the fixed frame (opposite one another and in contact in the closed configuration).

The sliding window or door structured in this way is amongst the most widespread and most used on the market, since it has a high level of active safety and is suitable for architectural solutions which require large glass window or door surfaces combined with limited overall dimensions.

However, in contrast to these undoubted advantages of the sliding window or door there is an insufficient level of heat insulation relative to the other types of windows or doors (see for example windows and doors with tilt and turn opening).

The causes of this insufficient heat seal may mostly be attributed (partly based on the many tests carried out) to the fixed frame of the window or door.

More precisely, the lower rail A and upper rail of the fixed frame, rails consisting of a base profile PB from which the two tracks B1 and B2 emerge, having common surfaces between the inner zone ZI and the outer zone ZE of the environment in which the window or door is mounted: said common zones are identifiable, in particular, in the above-mentioned parallel pair of sliding tracks B1 and B2.

The architecture used to allow the sliding of the sash or sashes A1 and A2, with relative overlapping of the sashes, leaves uncovered a good part of the surfaces corresponding to the sliding tracks B1 and B2, in the sense that there is a passage of heat between the outside and the inside (see FIGS. 1 and 2).

To overcome this deficiency there are currently solutions defined as being of the “thermal break” type, which can be produced on extruded aluminum profiles and substantially consist of bars G of polyamide (a material with a low level of heat transmission) which separates—in the middle—along the whole length the profile of each crosspiece of the window or door.

Thermal energy, that is to say heat, flows from one environment to another in three basic ways: conduction, convection, irradiation. The direction of transmission is from the environment with the higher temperature towards the environment with the lower temperature. If the two environments are separated by a partition, the amount of heat which passes through it is proportional to the difference in temperature.

In the case of the sliding windows or doors (as clearly shown in FIGS. 1 and 2), this thermal break system on the frame does not allow acceptable performance to be achieved because the metal surfaces of the rails with faces common to the outside and inside, are never completely separate and so still allow the passage of heat by conduction from the inside to the outside and vice versa on the individual tracks even in the presence of the insulating bars forming the thermal break.

Another particularly critical element of the sliding window or door as regards the heat seal is identifiable in the central zone in which the sashes A1 and A2 overlap in the closed configuration.

As FIG. 1 clearly shows, the space between the two tracks, common to the inside and the outside, may lack a heat seal: at present this zone is protected with an element which—in theory—acts as a “seal”, even if it has very approximate performance and absolutely does not allow a thermal break along the profile or a seal against the weather such as rain water.

In addition to this the new energy saving regulations will make it difficult to use this type of window or door if its performance cannot be adjusted in terms of insulation.

### SUMMARY OF THE INVENTION

The aim of the present invention is therefore to overcome these disadvantages by providing an accessory which, combined with the profile, has high level heat insulation and weather seal properties, maintaining mechanical and aesthetic properties similar to those of traditional type profiles.

Accordingly, the present invention achieves this aim with an accessory, in particular an accessory for profiles forming sliding windows or doors which has the technical features described in one or more of the claims herein.

### BRIEF DESCRIPTION OF THE DRAWINGS

The technical features of the invention, in accordance with the afore-mentioned aims, are clearly indicated in the claims herein and the advantages of the invention are more evident in the detailed description which follows, with reference to the accompanying drawings, which illustrate a preferred embodiment without limiting the scope of the invention, in which:

FIGS. 1 and 2 illustrate a profile for making sliding windows or doors of the known type, respectively in a top plan view and a schematic front view with some parts in cross-section and others cut away;

FIG. 3 is a top plan view of a profile equipped with the accessory, in accordance with the present invention;

FIG. 4 is an exploded perspective view of the accessory in accordance with the invention;

FIGS. 5 and 6 are respectively a side and a front view with some parts cut away to better illustrate others of the accessory of FIG. 4;

FIG. 7 is a perspective view with some parts cut away and others in cross-section of a detail of the accessory from FIGS. 4 to 6;

FIG. 8 is a schematic front view of a sliding window or door obtained with the profile in accordance with the present invention.

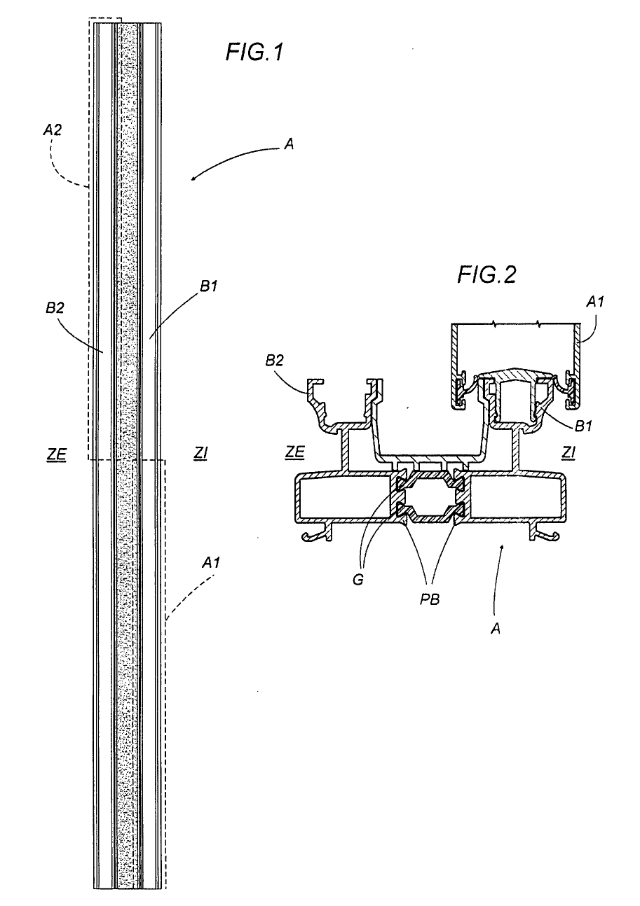

### DESCRIPTION OF THE PREFERRED EMBODIMENTS

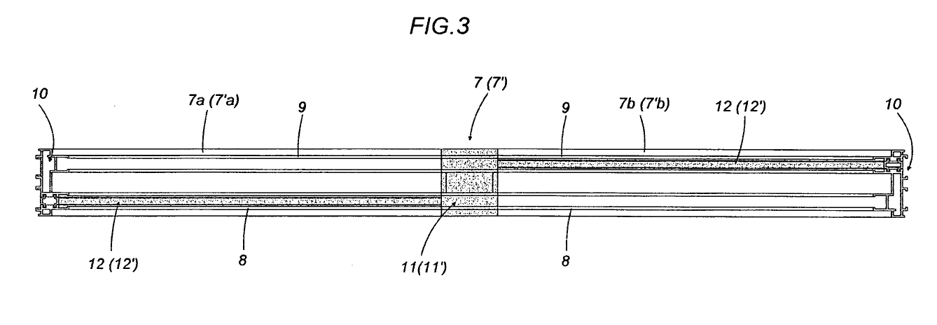

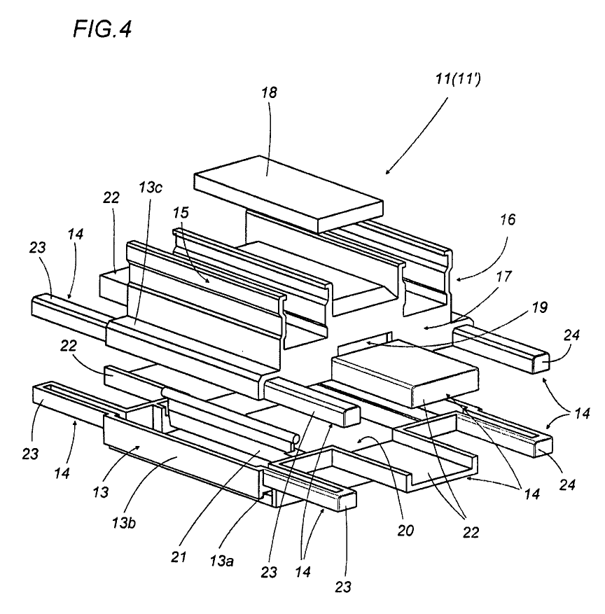

With reference to the accompanying drawings, and in particular with reference to FIGS. 3 and 4, the accessory, labeled 11 as a whole, is applied on profiles 7 used to make frames for sliding windows or doors 1 comprising, amongst other things, (FIG. 7) a fixed frame 2 formed by two crosspieces 3 and 4 and two stiles 5 and 6.

As FIG. 3 clearly shows, the profile 7, forming at least the first lower crosspiece 3, comprises two sliding tracks 8 and 9, parallel with one another, presented by a lower base body 10, and also comprises heat insulation elements 12.

Positioned on the two tracks 8 and 9 there may be, respectively, a first movable frame 50 and a second frame (movable or static) 51 which completes the structure of the sliding window or door 1.

FIG. 3 also shows how the profile 7 forming the lower crosspiece 3 has an element 11 for connecting and joining two halves 7a and 7b forming the profile 7, separated transversally relative to the length of the tracks 8 and 9 and together forming the entire lower crosspiece 3.

In addition, the connecting and joining element 11 has heat insulation properties.

Obviously, the profile 7′ forming the upper crosspiece 4 also has a second element 11′ for connecting and joining the two halves 7′a and 7′b forming the profile 7′, again separated transversally relative to the length of the tracks 8 and 9 and forming, together with the element 11′, the entire upper crosspiece 4.

Again, the connecting and joining element 11′ has heat insulation properties.

To simplify the description, reference is made to one element 11 or 11′, since these accessory elements are both the same in terms of architecture and structural equipment.

This connecting and joining element 11, 11′ forms the central portion of the profile 7, 7′ where the halves 7a, 7b; 7′a, 7′b are separated transversally and with substantially the same length.

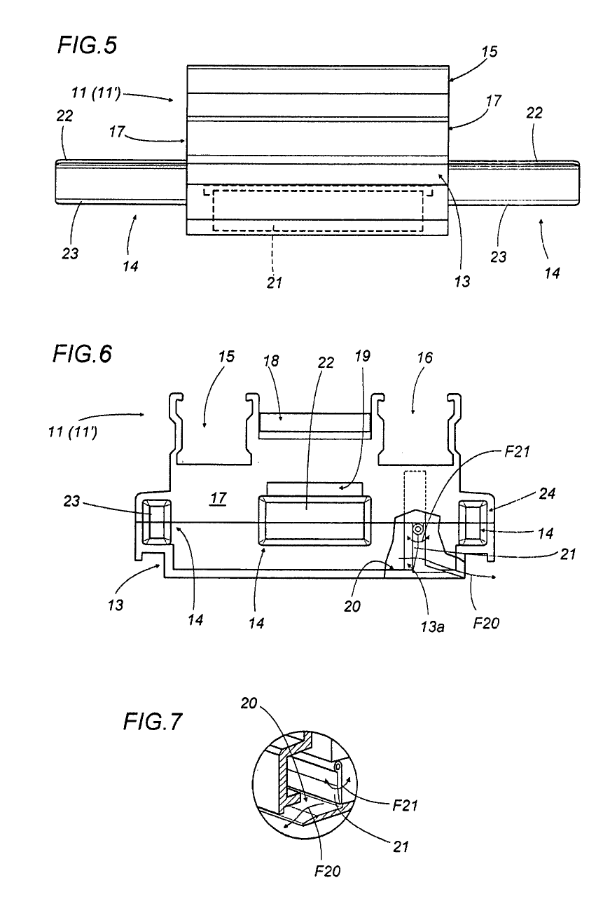

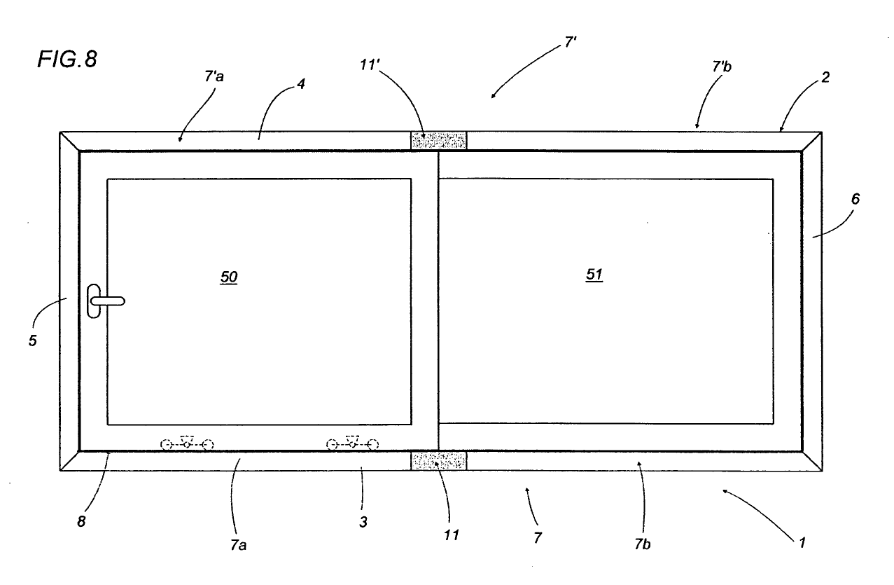

As illustrated in FIGS. 4 to 6, each connecting and joining element 11, 11′ comprises:
a base portion 13 which can be connected with a matching fit, on both sides, with the respective base ends of each half 7a, 7b, 7′a, 7′b of the profile 7, 7′ by relative connection elements 14 projecting from both sides of the base portion 13;
two pairs of upper projections 15 and 16, parallel with one another, forming relative connections or joins for the first and second tracks 8 and 9 of each half 7a, 7b, 7′a, 7′b, and so as to obtain, in practice, a relative first and second longitudinal track 8, 9 without interruption along the entire length of the profile 7, 7′.

In more detail, for each end side in contact with the halves 7a, 7b, 7′a, 7′b the base portion 13 comprises at least one vertical surface 17 for contact with the heat insulation or thermal break elements 12, 12′ positioned on the corresponding halves 7a, 7b, 7′a, 7′b of the profile 7, 7′ (for example, one or more flat rods extending below the tracks 8 and 9).

In addition, the base portion 13 may comprise, on the upper surface inserted between the two pairs of upper projections 15, 16, a seal element 18 or seal (for example made of rubber) between the two upper zones of each half 7a, 7b, 7′a, 7′b.

An additional feature of this element 11, 11′ is the presence, on one or, preferably, both end sides of the base portion 13, of an opening or slot 19 for the passage, in practice, of fluid, that is to say rain, so as to collect the latter in a lower part of the base portion 13, having a reservoir-style inner zone 20 for collecting the water.

Connected on one side of the lower part, in practice positioned towards the outside of the environment in which it is mounted, there is a valve element 21 designed to allow the water collected to be emptied to the outside.

In more detail, the valve element consists of a rigid wall 21 pivoting at both sides in the lower part of the base portion 13.

The rigid wall 21, substantially forming a door, is positioned close to an opening 13a made on the side part of the base portion 13 so that, when the rigid wall 21 is rotated (due to the quantity of water present in the reservoir 20), the water collected is emptied out (see arrows F20 and F21 in FIGS. 6 and 7).

In order to correctly apply the rigid wall 21 inside the connecting and joining element 11, 11′, the base portion 13 may be divided into two halves, upper 13b and lower 13c, which can be connected during assembly to form the element 11, 11′.

The connection elements 14 may vary in shape and number depending on the type of cross-section of the halves 7a, 7b, 7′a, 7′b of the profile 7, 7′.

In the case illustrated, by way of example only and without limiting the scope of the invention, the connection elements 14 consist of a horizontal projection 22 projecting from each of the end sides of the base portion 13 and connecting, with a matching fit, by sliding, with a portion of the relative half 7a, 7b, 7′a, 7′b of the profile 7, 7′.

In addition there is a pair of second rods 23, 24, projecting from the relative end sides of the base portion 13, each pair 23 and 24 positioned on both sides of the first horizontal projection 22 and designed to connect with a matching fit, by sliding, in a relative portion of a corresponding half 7a, 7b, 7′a, 7′b of the profile 7, 7′.

Therefore, with an accessory structured in this way the preset aims are achieved with a simple architectural variation of the conventional type of profiles and the addition of the connecting and joining element 11, 11′.

The presence of the accessory allows heat seal results to be achieved which are better than those on conventional profiles.

Interrupting the lower and, if necessary, upper tracks, connecting with the insertion of the joining accessory or plug, allows the creation of an effective thermal barrier which, for each surface facing the outside, has a thermal break system without any uninterrupted element between the inside and the outside.

Finally, with this accessory, the profile made in this way achieves a plurality of advantages which may be summarized as follows:
improved overall thermal performance of the sliding window or door mounted;
reduced working on the frame profile;
improved resistance to infiltration by water thanks to the increase in the capacity of the drainage devices and the structuring of the joining plug, without the need for additional work on the profile;
improved frame transportability thanks to the possibility of assembling the plugs on site and therefore with greatly reduced crosspiece sizing;
simplification of the process for making the window or door as a whole.

The invention described above is susceptible of industrial application and may be modified and adapted in several ways without thereby departing from the scope of the inventive concept. Moreover, all details of the invention may be substituted by technically equivalent elements.

1. An accessory for profiles used for making frames for sliding windows or doors comprising, amongst other things, at least one fixed frame formed by two crosspieces and two stiles; a profile, forming at least a first lower crosspiece, comprising two sliding tracks, parallel with one another, and presented by a lower base body and heat insulation elements, wherein at least the profile forming the lower crosspiece has an element for connecting and joining two halves of the profile, separated transversally relative to the length of the tracks and forming the whole lower crosspiece; the connecting and joining element having heat insulation properties.

2. The accessory according to claim 1, wherein at least the profile forming the upper crosspiece has a second element for connecting and joining two halves of the profile, separated transversally relative to the length of the tracks and forming the entire upper crosspiece; the connecting and joining element having heat insulation properties.

3. The accessory according to claim 1, wherein the connecting and joining element forms the central portion of the profile in which the halves are separated transversally and with equal length.

4. The accessory according to claim 1, wherein each connecting and joining element comprises:
a base portion which can be connected with a matching fit, on both sides, with the respective base ends of each half of the profile by relative connection elements projecting from both sides of the base portion;
two pairs of upper projections, parallel with one another, forming relative connections or joins for the first and second tracks of each half, and so as to obtain, in practice, a relative first and second longitudinal track without interruption along the entire length of the profile.

5. The accessory according to claim 4, wherein, for each end side in contact with the halves the base portion comprises at least one vertical surface for contact with heat insulation or thermal break elements positioned on the corresponding halves of the profile.

6. The accessory according to claim 4, wherein the base portion comprises, on the upper surface inserted between the two pairs of upper projections, a seal element or seal between the two upper zones of each half.

7. The accessory according to claim 4, wherein at least on one end side of the base portion there is an opening or slot for the passage, in practice, of fluid, that is to say rain, so as to collect the latter in a lower part of the base portion, having a reservoir-style inner zone for collecting the water; there being connected on one side of the lower part, positioned towards the outside of the environment in which it is mounted, a valve element designed to allow the water collected to be emptied to the outside.

8. The accessory according to claim 7, wherein the valve element consists of a rigid wall pivoting at both sides in the lower part of the base portion; the rigid wall being positioned close to an opening made on the side part of the base portion so that, when the rigid wall is rotated, the water collected is emptied out.

9. The accessory according to claim 4, wherein on both end sides of the base portion there is an opening or slot for the passage, in practice, of fluid, that is to say rain, so as to collect the latter in a lower part of the base portion, having a reservoir-style inner zone for collecting the water.

10. The accessory according to claim 4, wherein the connection elements consist of at least one horizontal projection projecting from each of the end sides of the base portion and connecting with a matching fit with a portion of the relative half of the profile.

11. The accessory according to claim 4, wherein the connection elements consist of a first horizontal projection projecting from each of the end sides of the base portion and connecting with a matching fit with a portion of the relative half of the profile; there being a pair of second rods, projecting from the relative end sides of the base portion, each pair of second rods being positioned on both sides of the first horizontal projection and designed to connect with a matching fit in a relative portion of a corresponding half of the profile.

12. The accessory according to claim 4, wherein the base portion is divided into two halves, upper and lower, which can be connected during assembly.

13. The accessory according to claim 2, wherein the connecting and joining element forms the central portion of the profile in which the halves are separated transversally and with equal length.

14. The accessory according to claim 2, wherein each connecting and joining element comprises:
a base portion which can be connected with a matching fit, on both sides, with the respective base ends of each half of the profile by relative connection elements projecting from both sides of the base portion;
two pairs of upper projections, parallel with one another, forming relative connections or joins for the first and second tracks of each half, and so as to obtain, in practice, a relative first and second longitudinal track without interruption along the entire length of the profile.
